(19) United States
(12) Patent Application Publication
(10) Pub. No.: US 2025/0207622 A1
(43) Pub. Date: Jun. 26, 2025

(54) NUT FOR SECURING A COMPONENT TO A SUPPORT

(71) Applicant: BLANCO GMBH + CO KG, Oberderdingen (DE)

(72) Inventor: Ingo HAUSER, Kandern (DE)

(73) Assignee: BLANCO GMBH + CO KG, Oberderdingen (DE)

(21) Appl. No.: 18/985,686

(22) Filed: Dec. 18, 2024

(30) Foreign Application Priority Data
Dec. 20, 2023 (DE) 10 2023 213 126.9

(51) Int. Cl. F16B 37/08

(52) U.S. Cl. CPC F16B 37/08

(57) ABSTRACT

The invention relates to a nut for securing a component to a support, in particular a sanitary fitting to a worktop, comprising a first nut part, and a second nut part, wherein the first nut part has at least two threaded tabs with threads on their radially inner side, and the two nut parts are arranged to be displaceable relative to one another along an axial axis, such that in a first position—open position—the threaded tabs of the first nut part can be arranged to protrude radially outward, and in a second position—closed position—the threaded tabs of the first nut part can be arranged by means of the second nut part, in particular extending radially inward, to engage with a corresponding external thread of the component, wherein the first and second nut parts are configured to be freely rotatable relative to each other around the axial axis.

The invention relates to a nut for securing a component to a support, in particular a sanitary fitting to a worktop, comprising a first nut part and a second nut part. The first nut part has at least two threaded tabs, which have a thread on their radial inner side. The two nut parts are arranged to be displaceable relative to each other along an axial axis, such that in a first position—the open position—the threaded tabs of the first nut part can be arranged to project radially outward, and in a second position—the closed position—the threaded tabs of the first nut part can be arranged, by means of the second nut part, in particular projecting radially inward, to engage a corresponding external thread of the component.

The invention further relates to a system for securing a component to a support, comprising a nut.

The invention additionally relates to a method for securing a component to a support.

The invention also relates to a method for releasing a component secured to a support.

Although applicable to any components, the present invention is described in relation to components in the form of sanitary fittings.

Although applicable to any supports, the present invention is described in relation to supports in the form of worktops.

Sanitary fittings are well known in a variety of forms. These are typically secured to a worktop by the sanitary fitting extending with a corresponding shaft partially through a mounting hole in the worktop. To secure the sanitary fitting, the shaft of the fitting has an external thread onto which a nut is screwed.

The issue here is that the shaft of the fitting is often long to allow use with worktops of varying thickness. For thin worktops, during the installation of the sanitary fitting, it becomes laborious and time-consuming to screw the nut onto the external thread of the shaft to its final securing position.

From DE 10 2021 212 266 A1, a nut for securing a component to a support, in particular a sanitary fitting to a worktop, is known. It comprises a first nut part and a second nut part, wherein the first nut part has at least two threaded tabs on its radial inner side, which have a thread. The threaded tabs are arranged to project radially outward at a first angle. The two nut parts are arranged to be axially displaceable relative to each other, such that in a first position—the open position—the threaded tabs of the first nut part are arranged to project radially outward, and in a second position—the closed position—the threaded tabs of the first nut part are pressed radially inward by the second nut part to engage a corresponding external thread of the component.

However, the disadvantage of this design is that, for mounting a sanitary fitting, for example on a worktop, an additional stabilizing component is required. Moreover, high precision is required during the production of the nut to prevent the threaded tabs from being positioned in a way unsuitable for fastening. This results in relatively high production costs.

The object of the present invention is, therefore, to provide a nut for securing a component to a support and a system for securing a component to a support, which are simple and cost-effective to produce, enable easy and rapid securing and releasing of the component and require as few additional components as possible.

Another object of the present invention is to provide an alternative nut for securing a component to a support and an alternative system for securing a component to a support.

A further object of the present invention is to provide a method for securing a component to a support and a method for releasing a component secured to a support, which can be carried out simply, quickly and reliably, with reduced operating space required for assembly by a technician.

An additional object of the present invention is to provide an alternative method for securing a component to a support and an alternative method for releasing a component secured to a support.

In one embodiment, the present invention solves the aforementioned objects with a nut for securing a component to a support, in particular a sanitary fitting to a worktop, comprising:
a first nut part, and
a second nut part, wherein
the first nut part has at least two threaded tabs, which have a thread on their radial inner side. The two nut parts are arranged to be displaceable relative to each other along an axial axis, such that in a first position-the open position-the threaded tabs of the first nut part can be arranged to project radially outward, and in a second position-the closed position-the threaded tabs of the first nut part, by means of the second nut part, in particular projecting radially inward, can be arranged to engage a corresponding external thread of the component,
characterized in that the first and second nut parts are configured to be freely rotatable relative to each other around the axial axis.

In another embodiment, the invention solves the aforementioned objects with a system for securing a component to a support, comprising
a nut according to one of claims 1-19, wherein the component has an external thread corresponding to the thread of the nut, such that the nut can be screwed onto the external thread in its closed position, and in its open position, the thread has an internal diameter at least in one region that is greater than the external diameter of the external thread.

In a further embodiment, the invention solves the aforementioned objects with a method for securing a component to a support, comprising the steps:
Providing a nut according to one of claims 1-19 in the open position,
Providing a component with an external thread corresponding to the thread of the nut, such that the nut can be screwed onto the external thread in its closed position,
Positioning the component on the support,
Sliding the nut in its open position over the external thread of the component until the nut's second nut part contacts the support,
Actuating the first nut part until the nut reaches its closed position, engaging the thread with the external thread of the component, and
Rotating the nut to secure the component to the support.

In another embodiment, the invention solves the aforementioned objects with a method for releasing a component secured to a support, comprising the steps:
Providing a nut according to one of claims 1-19 in its closed position on the component, wherein the component has an external thread corresponding to the thread of the nut, and the thread of the nut engages the external thread of the component,
Actuating the thread of the nut by rotating the nut to release the component from the support until the nut reaches its open position, and
Releasing the nut by moving it into its open position over the external thread of the component to release the component from the support.

One advantage achieved is the simplified assembly of components to supports using the nut. Another advantage is that, during assembly, the nut is essentially self-closing from its open position to its closed position, enabling quick assembly with minimal effort. A further advantage is the simple and cost-effective production of the two nut parts, for instance from plastic, preferably using injection molding. The free rotation of the two nut parts relative to each other allows stabilizing elements to be arranged directly on or with the nut, reducing additional components. Furthermore, a stabilizing element can, for example, be freely aligned during assembly on a worktop or similar support.

The term “free rotation” with respect to the two nut parts is to be understood in the broadest sense and refers, in particular in the claims and preferably in the description, to the possibility of unrestricted relative rotation, irrespective of the direction of rotation, especially in at least one direction of rotation of the two nut parts in the open position, during the transition from the open to the closed position or vice versa, and/or in the closed position. This specifically only requires the objective possibility of free rotation, regardless of any forces, such as friction, that may need to be overcome.

The feature “arranged to project radially outward” with respect to the feature “threaded tab” is to be understood in the broadest sense and refers, in particular in the claims and preferably in the description, to the possibility of movement outward without requiring that the threaded tab necessarily moves outward during actuation of the two nut parts. The threaded tabs are preferably arranged parallel to the axial direction and/or radially inward with respect to the nut parts.

Further features, advantages and embodiments of the invention are described below or become apparent as follows.

According to a preferred embodiment an advantageous further development of the invention, the first and second nut parts can be secured to each other by means of a securing device, which is designed to be releasable. The advantage of this is flexible and straightforward securing of the two nut parts to each other, for example to provide limited axial displaceability. The nut parts can thereby be releasably secured to each other.

According to a further preferred embodiment advantageous development of the invention, the securing device includes a locking, clipping or snapping mechanism. The advantage of this is the simple and quick securing of the two nut parts to each other.

According to another preferred embodiment advantageous development of the invention, the securing device includes at least one guide slot into which at least one guide element engages, in particular wherein the at least one guide slot is arranged in the second nut part and the guide element is arranged on the first nut part. This provides simple and at the same time reliable guidance of the two nut parts. The term “guide slot” is to be understood in the broadest sense and refers, in particular in the claims and preferably in the description, to recesses, openings, projections, indents or the like, which at least partially restrict the mobility of a guide element within the guide slot.

According to a further preferred embodiment advantageous development of the invention, the securing device includes sliding surfaces on the first and second nut parts, which are sloped at an angle relative to the axial direction, in particular where the angle relative to the axial direction is at least 5 degrees, especially at least 10 degrees, preferably at least 15 degrees and particularly at least 30 degrees. This provides a sufficiently large pressing force of the threaded tabs on an external thread in the closed position without significantly increasing the size of the nut.

According to another preferred embodiment advantageous development of the invention, a return mechanism is arranged, which is designed to exert a restoring force towards the open position. This ensures that the nut can be easily released, for example when the component needs to be replaced for maintenance purposes. If the nut is actuated accordingly, it automatically moves into its open position, so that it can be quickly and easily removed, for example from a sanitary fitting shaft.

According to another preferred embodiment advantageous development of the invention, the return mechanism includes a spring device with at least one spring element, which is arranged between the first and second nut parts. The advantage of this is the simple and reliable provision of a restoring force.

According to another preferred embodiment advantageous development of the invention, at least one retaining element, in particular multiple retaining elements, is arranged on the second nut part, wherein the at least one spring element can be supported on the at least one retaining element. The advantage of this is the reliable provision of a restoring force by the spring element.

According to another preferred embodiment advantageous development of the invention, a retaining element is designed as a rim of the second nut part. The advantage of this is that no separate retaining elements need to be manufactured.

According to another preferred embodiment advantageous development of the invention, the at least one spring element is designed as a disc spring, which is arranged releasably between the first and second nut parts, or the at least one spring element is designed as at least two projections, in particular symmetrically arranged on the first and/or second nut part, directed towards the respective other nut part. The advantage of a spring, in particular made of metal, preferably a disc spring, is the reliable provision of spring force. The advantage of elastic and/or resilient projections, which are, for example, curved and arranged along the imagined circumferential surface of the first nut part, is cost-effective production, as these can, for example, be directly formed onto the first nut part or integrally manufactured with it.

According to another preferred embodiment advantageous development of the invention, the return mechanism and the securing device are designed to interact to provide the open position. This enables a reduction in the total number of components, which lowers manufacturing costs.

According to another preferred embodiment advantageous development of the invention, the threaded tabs are arranged parallel to the axial direction in their unloaded state. This enables the simple production of the threaded tabs while maintaining high tolerances during manufacturing, without compromising the engagement of the threaded tabs with an external thread.

According to another preferred embodiment advantageous development of the invention, the number of threaded tabs is fewer than 30, preferably fewer than 15, in particular fewer than 8, preferably 4 and more than 2. This provides a sufficient number of threaded tabs while ensuring reliable engagement in the closed position.

According to another preferred embodiment advantageous development of the invention, an open-hold device is arranged to provide the open position. This enables particularly simple assembly.

According to another preferred embodiment advantageous development of the invention, the open-hold device includes at least one elongated element, which is held in or on at least one opening, in particular in a form-fitting or frictional manner, and during the transition from the open to the closed position, engages the at least one opening. In particular, the at least one elongated element and the at least one opening are arranged on the first nut part. The advantage of this is the straightforward handling of the nut during assembly. A form-fitting arrangement of the elongated element can be achieved, for example, by one or more narrow ribs that serve as predetermined breaking points within the opening. These ribs hold the elongated element in or on the opening and, when force is applied—i.e. when the two nut parts are pushed together—break, allowing the elongated element to be pressed or pushed into the opening.

According to another preferred embodiment advantageous development of the invention, the first nut part is partially arranged within the second nut part and the first nut part is at least partially arranged on the radial outer side of the second nut part, or vice versa. The advantage of this is a defined arrangement and guidance of the two nut parts relative to each other, which simplifies handling of the nut, in particular during assembly.

According to another preferred embodiment advantageous development of the invention, the second nut part includes, on the axial side facing away from the first nut part, a contact device for positioning the nut on the component. This enables the reliable securing of the component to a support using the nut.

According to another preferred embodiment advantageous development of the invention, the contact device comprises a planar component, which is in particular triangular. The advantage of this is reliable securing with minimal material usage for the contact device, which can assist in aligning the component to the support using the nut.

According to another preferred embodiment advantageous development of the invention, the contact device includes at least one, in particular several, material weakenings, in particular slots, for separation. The advantage of this is the high adaptability of the nut on-site by the technician. The technician can adapt the contact device to local conditions on-site with minimal effort.

Further important features and embodiments advantages of the invention emerge from the dependent claims, the drawings and the corresponding description of the figures based on the drawings.

It is understood that the features mentioned above and those to be explained below can be used not only in the specified combinations but also in other combinations or individually, without departing from the scope of the present invention.

Preferred embodiments and configurations of the present invention are illustrated in the drawings and explained in more detail in the following description, where identical reference numerals refer to identical, similar or functionally equivalent components or elements.

In the drawings:

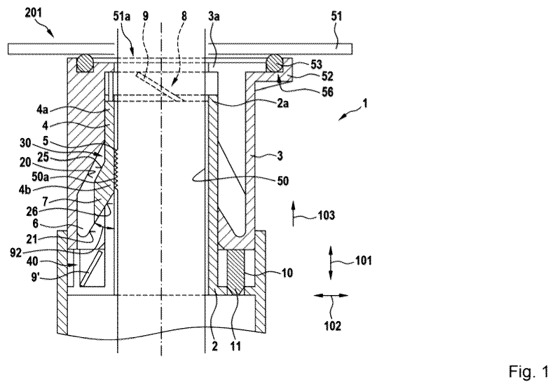

FIG. 1 shows a system with a nut according to an embodiment of the present invention in cross-section in an open position;

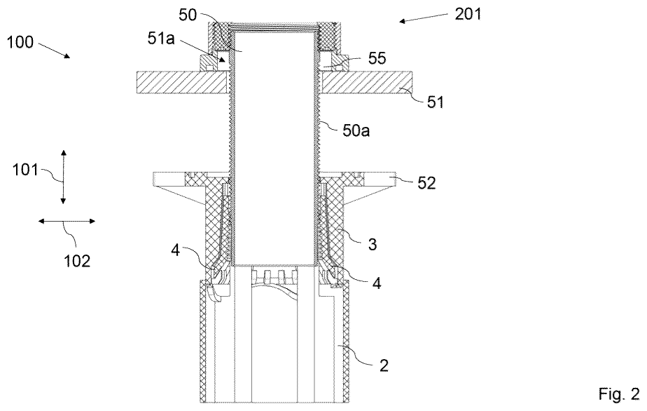

FIG. 2 shows a system with a nut according to an embodiment of the present invention in cross-section in an open position;

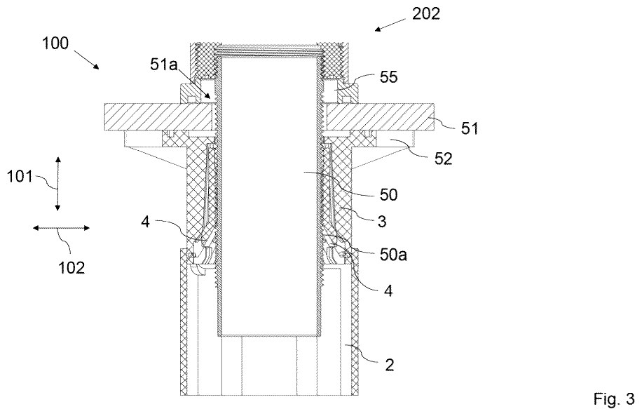

FIG. 3 shows the system from FIG. 2 in a closed position;

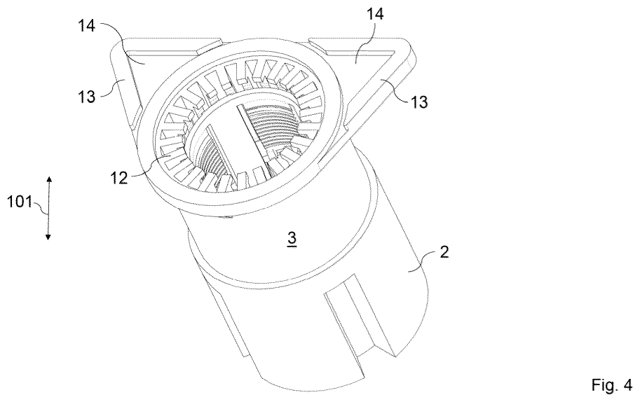

FIG. 4 shows a three-dimensional top view of a nut according to an embodiment of the present invention;

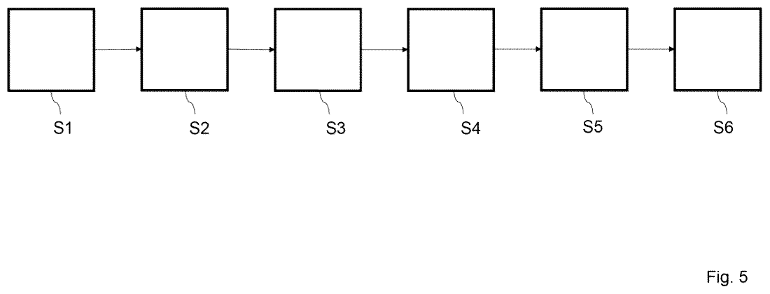

FIG. 5 shows schematic steps of a method according to an embodiment of the present invention; and

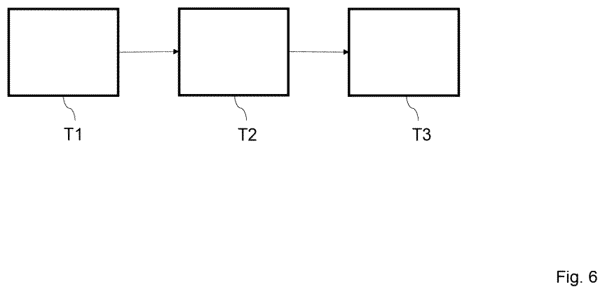

FIG. 6 shows schematic steps of a method according to an embodiment of the present invention.

FIG. 1 shows a system with a nut according to an embodiment of the present invention in cross-section in an open position.

In FIG. 1, a system 100 with a nut 1 in its open position 201 is shown. The nut 1 comprises a first nut part 2 and a second nut part 3. Both nut parts 2 and 3 are circular in cross-section and arranged along an axial direction 101. In the illustration in FIG. 1, the essentially cylindrical nut 1 is depicted wider to the right of the axial direction than to the left, for illustrative clarity.

The first nut part 2 also has threaded tabs 4, which are arranged parallel to the axial direction 101 in the open position 201, where the threaded tabs 4 are radially unstressed. A starting section 4a of a threaded tab 4 is positioned essentially adjacent to or parallel to the surface of the first nut part 2, as is an end section 4b. In the end section 4b, two sliding surfaces 25 and 26 are arranged on the radial outer side. These sliding surfaces are inclined radially outward (in the radial direction 102) at an angle 92 relative to the axial direction 101. These sliding surfaces 25 and 26, which in the end section 4b essentially form a parallelogram in cross-section, engage via a connection 30 in a guide slot 6 or recess of the second nut part 3. The guide slot is also essentially trapezoidal, specifically parallelogram-shaped, in cross-section. It allows both limited axial displacement along the axial direction 101 of the two sliding surfaces 25 and 26 and limited radial outward movement of the end section 4b. The end section 4b with the aforementioned sliding surfaces 25 and 26 thus functions as a guide element 7. The guide slot 6 includes an upper sliding surface 20 and a lower sliding surface 21, where the upper sliding surface 20 in the axial direction 101 corresponds to sliding surface 25 and the lower sliding surface 21 corresponds to sliding surface 26 of the guide element 7.

The second nut part 3 is—like the first nut part 2—essentially designed as a hollow cylinder, with the inner diameter of the second nut part 3 configured so that the second nut part 3 can enclose the first nut part 2 or accommodate the first nut part 2 at least partially within it. The second nut part 3 has a radially inwardly projecting circumferential rim 3a at its upper edge, which serves as a stop for the upper edge 2a of the first nut part 2. In addition, the circumferential rim 3a also acts as an insertion aid during assembly and protects the first nut part 2 during installation, preventing the thread 5 from damaging the first nut part 2.

If the first nut part 2 is pushed further into the second nut part 3 along the axial direction 101 from the open position 201—i.e. if the upper edge 2a moves towards the rim 3a in the securing direction 103—the sliding surface 26 no longer contacts the sliding surface 21. Instead, the axial movement causes the sliding surfaces 20 and 25 to press against each other. This forces the end section 4b radially inward towards a component 50 with an external thread 50a arranged within the first nut part 2, enabling the thread 5 of the threaded tabs 4 to engage with the external thread 50a of the component 50 arranged in the first nut part 2. The nut 1 can then be secured to the component 50 by rotating the first nut part 2. The component 50 itself passes through a corresponding opening 51a in a worktop 51 or a kitchen sink.

In addition, a stabilization triangle 52 is arranged at the upper section of the second nut part 3. A ring seal 53, which is supported in a recess or projection 56 in the upper section of the second nut part 3, may also be positioned there.

To make it easier to release the nut 1, one or more spring elements 9 of a spring mechanism 8 are arranged between the first nut part 2 and the second nut part 3. These provide a restoring force that pushes the first nut part 2 towards the open position 201. Although the nut 1 can also be released without spring elements 9, the spring elements 9 ensure that the nut 1 automatically adopts its open position and, after one or more rotations, reaches the open position 201, allowing the nut 1 to be removed for disassembly without further rotation.

Alternatively or additionally to a spring element, a pin 11 extending upwards in the axial direction 101 can be arranged on the first nut part 2 in the radial outer section. This pin can engage in a corresponding opening 10 in the first nut part 2. The pin 11 may be held in the opening 10 by one or more ribs, ensuring that the two nut parts 2 and 3 can rotate freely relative to each other while maintaining a gap in the open position 201. When the nut 1 is secured, the pin 11 is pushed into the opening 10 by breaking the ribs, regardless of the circumferential position of the two nut parts 2 and 3 relative to each other.

The thread 5 of the threaded tabs 4 may be tapered in the area adjacent to the starting section 4a, meaning that one or more thread turns are shortened to provide minimal overlap with the external thread 50a of a component 50. This facilitates the sliding of the nut 1 onto the external thread 50a of a component 50.

Alternatively or additionally, the spring mechanism 8 with a spring element 9′ can be arranged, instead of at the position above the first nut part 2, in the lower region of the first nut part 2 or in the transition area 40 between the first and second nut parts 2, 3. The spring element 9′ is positioned on the first nut part 2 and rests against the lower section of the second nut part 3. This configuration then pushes the second nut part 3 upwards relative to the first nut part 2 along the axial direction 101. An advantage of such an arrangement is that the total vertical extension along the axial direction 101 can be reduced compared to the arrangement of the spring mechanism 8 with the spring element 9. Conversely, the arrangement shown in FIG. 1 has the advantage of reducing the width of the nut 1, i.e. the diameter perpendicular to the axial direction 101.

The spring element 9 and/or the spring element 9′ can each be designed as an additional component, in particular in the form of a disc spring. Each spring element 9, 9′ can then be configured to be held or inserted in a form-fitting manner on the first nut part 2.

FIG. 2 shows a system with a nut according to an embodiment of the present invention in cross-section in an open position and FIG. 3 shows the system from FIG. 2 in a closed position.

In FIG. 2, a nut 1 is shown in its open position 201, as in FIG. 1, and in FIG. 3, in its closed position 202. Essentially, the nut 1 in FIGS. 2 and 3 corresponds to the nut 1 in FIG. 1.

In the closed position 202, the upper edge 2a (see FIG. 1) rests directly against the rim 3a (see FIG. 1), and the threaded tabs 4 are pressed inward or fixed radially in their position parallel to the axial direction 101. In other words, the threaded tabs 4 cannot move radially outward due to the sliding engagement of the sliding surfaces 20 and 25 (see FIG. 1) of the first and second nut parts 2, 3, which are pressed against each other. The component 50, as in the preceding figures, passes through an opening 51a and is secured to the upper side of the worktop 51 or a similar structure with a base body 55 of a fitting by means of a screw connection.

FIG. 4 shows a three-dimensional top view of a nut according to an embodiment of the present invention.

In FIG. 4, an angled top view of the second nut part 3 is shown. In the upper region, two triangular planar projections 13 extend perpendicularly to the axial direction 101, each featuring recesses 14. These recesses 14 can, for example, be cut through using a cutting tool to adapt the projections 13 to local conditions.

Together, the two projections 13 and the upper second nut part 3 form a stabilization triangle, which lies flush against a surface, such as a worktop, from below, preventing tilting of a sanitary fitting secured to the worktop.

To support one or more spring elements 9 of the spring mechanism 8, which is arranged between the two nut parts 2, 3 and pushes them apart in the axial direction 101 with a preload, hook- or L-shaped projections 12 extending radially inward and downward are arranged in the upper region of the second nut part 3. These projections 12 can support, for example, a spring element 9 in the form of a disc spring.

FIG. 5 illustrates, in schematic form, the steps of a method according to an embodiment of the present invention.

FIG. 5 shows the steps of a method for securing a component to a support.

The method comprises the following steps:
Providing S1 a nut 1 according to one of claims 1-19 in the open position 201,
Providing S2 the component 50, where the component 50 has an external thread 50a that corresponds to the thread 5 of the nut 1, such that the nut 1 can be screwed onto the external thread 50a in its closed position 202,
Positioning S3 the component 50 on the support 51,
Sliding S4 the nut 1 in its open position 201 over the external thread 50a of the component 50 until the nut 1 contacts the support 51 with its second nut part 3,
Actuating S5 the first nut part 2 until the nut 1 reaches its closed position 202, engaging the thread 5 with the external thread 50a of the component 50, and
Securing S6 the thread 5 of the nut 1 by rotating the nut 1 to secure the component 50 to the support 51.

FIG. 6 illustrates, in schematic form, the steps of a method according to an embodiment of the present invention.

FIG. 6 shows the steps of a method for releasing a component 50 secured to a support 51, comprising the following steps:
Providing T1 a nut 1 according to one of claims 1-19 in its closed position 202 on the component 50, where the component 50 has an external thread 50a that corresponds to the thread 5 of the nut 1, and the thread 5 of the nut 1 engages the external thread 50a of the component 50,
Actuating T2 the thread 5 of the nut 1 by rotating the nut 1 to release the component 50 from the support 51 until the nut 1 reaches its open position 201, and
Releasing T3 the nut 1 by moving it into its open position 201 over the external thread 50a of the component 50 to detach the component 50 from the support 51.

In summary, at least one embodiment of the present invention includes at least one of the following features and/or provides at least one of the following advantages:
Simple, cost-effective and rapid assembly and disassembly.
Simple, cost-effective manufacturing.
Few components for the nut.
“Self-closing” nut.
Elimination of additional components, such as a stabilization triangle and/or a washer.
Controlled positioning of the threaded tabs on the first nut part by the second nut part.

Although the present invention has been described with reference to preferred exemplary embodiments, it is not limited to them but is modifiable in many ways.

### REFERENCE LIST

1 Nut
2 First nut part
2a Edge
3 Second nut part
3a Rim
4 Threaded tab
4a Starting section
4b End section
5 Thread
6 Guide slot
7 Guide element
8 Spring mechanism
9, 9′ Spring element
10 Recess
11 Pin
12 Projection
13 Planar projection
14 Recess
20 Upper sliding surface
21 Lower sliding surface
25 Sliding surface
26 Sliding surface
30 Clip connection
40 Transition/contact area
50 Component
50a External thread
51 Support
51a Opening
52 Stabilization triangle
53 Ring seal
55 Fitting base body
56 Projection
92 Angle
100 System
101 Axial direction
102 Radial direction
103 Securing direction
201 Open position
202 Closed position
S1-S6 Method steps
T1-T3 Method steps

1. A nut for securing a component to a support, in particular a sanitary fitting to a worktop, comprising
a first nut part, and
a second nut part, wherein
the first nut part has at least two threaded tabs on its radially inner side, each with a thread, and wherein the two nut parts are arranged to be displaceable relative to one another along an axial axis, such that, in a first position—open position—the threaded tabs of the first nut part can be arranged to protrude radially outward, and in a second position—closed position—the threaded tabs of the first nut part can be arranged, by means of the second nut part, in particular extending radially inward, to engage with a corresponding external thread of the component, characterized in that the first and second nut parts are configured to be freely rotatable relative to each other about the axial axis.

2. A nut according to claim 1, characterized in that the first nut part and the second nut part can be secured to each other by means of a securing device, which is in particular designed to be releasable.

3. A nut according to claim 2, characterized in that the securing device includes a locking, clipping or snapping mechanism.

4. A nut according to claim 2, characterized in that the securing device includes at least one guide slot, into which at least one guide element engages, in particular wherein the at least one guide slot is arranged in the second nut part and the guide element is arranged on the first nut part.

5. A nut according to claim 1, characterized in that the securing device includes sliding surfaces on the first and second nut parts, which are sloped at an angle relative to the axial direction, in particular where the angle relative to the axial direction is at least 5 degrees, especially at least 10 degrees, preferably at least 15 degrees and in particular at least 30 degrees.

6. A nut according to claim 1, characterized in that a return mechanism is arranged to exert a restoring force towards the open position.

7. A nut according to claim 6, characterized in that the return mechanism includes a spring mechanism with at least one spring element arranged between the first and second nut parts.

8. A nut according to claim 7, characterized in that at least one retaining element, in particular multiple retaining elements, are arranged on the second nut part, and the at least one spring element can be supported on the at least one retaining element.

9. A nut according to claim 8, characterized in that a retaining element is configured as a rim of the second nut part.

10. A nut according to claim 7, characterized in that the at least one spring element is configured as a disc spring arranged releasably between the first and second nut parts, or the at least one spring element is configured as at least two projections, in particular symmetrically arranged on the first and/or second nut part, extending towards the respective other nut part.

11. A nut according to claim 1, characterized in that the return mechanism and the securing device are configured to interact to provide the open position.

12. A nut according to claim 1, characterized in that the threaded tabs are arranged parallel to the axial direction in their unloaded state.

13. A nut according to claim 1, characterized in that the number of threaded tabs is fewer than 30, preferably fewer than 15, in particular fewer than 8, preferably 4 and more than 2.

14. A nut according to claim 1, characterized in that an open-hold device is arranged to provide the open position.

15. A nut according to claim 14, characterized in that the open-hold device includes at least one elongated element, which is held in or on at least one opening, in particular in a form-fitting or friction-locking manner, and engages with the at least one opening during the transition from the open position to the closed position, in particular wherein the at least one elongated element and the at least one opening are arranged on the first nut part.

16. A nut according to claim 1, characterized in that the first nut part is partially arranged within the second nut part, and the first nut part is at least partially arranged on the radial outer side of the second nut part, or vice versa.

17. A nut according to claim 1, characterized in that the second nut part includes, on the axial side facing away from the first nut part, a contact device for positioning the nut on the component.

18. A nut according to claim 17, characterized in that the contact device comprises a planar component, in particular triangular in shape.

19. A nut according claim 17, characterized in that the contact device includes at least one, in particular multiple, material weakenings, in particular slots, for separation.

20. A system for securing a component to a support,
a nut according to claim 1, wherein the component has an external thread corresponding to the thread of the nut, such that the nut can be screwed onto the external thread in its closed position, and wherein in its open position, the thread is provided, at least in one section (4b), with an internal diameter greater than the external diameter of the external thread.

21. A method for securing a component to a support, comprising the steps:
providing (S1) a nut according to claim 1 in the open position,
providing (S2) the component, wherein the component has an external thread corresponding to the thread of the nut, such that the nut can be screwed onto the external thread in its closed position,
positioning (S3) the component on the support,
sliding (S4) the nut in its open position over the external thread of the component until the nut contacts the support with its second nut part,
actuating (S5) the first nut part until the nut reaches its closed position, engaging the thread with the external thread of the component, and
securing (S6) the thread of the nut by rotating the nut to secure the component to the support.

22. A method for releasing a component secured to a support, comprising the steps:
providing (T1) a nut according to claim 1 in its closed position on the component, wherein the component has an external thread corresponding to the thread of the nut, and wherein the thread of the nut engages the external thread of the component,
actuating (T2) the thread of the nut by rotating the nut to release the component from the support until the nut reaches its open position, and
releasing (T3) the nut by moving it into its open position over the external thread of the component to release the component from the support.
